(19) United States
(12) Patent Application Publication
(10) Pub. No.: US 2004/0123427 A1
(43) Pub. Date: Jul. 1, 2004

(54) Adjustable handle assembly for a lock

(75) Inventor: Mei Kuei Lee, Kaohsiung Hsien (TW)

Correspondence Address: BACON & THOMAS, PLLC, 625 SLATERS LANE, FOURTH FLOOR, ALEXANDRIA, VA, 22314

(73) Assignee: Taiwan Fu Hsing Industrial Co., Ltd., Kaohsiung Hsien (TW)

(21) Appl. No.: 10/330,084

(22) Filed: Dec. 30, 2002

(51) Int. Cl. E05B 1/00

(52) U.S. Cl. 16/412

(57) ABSTRACT

An adjustable handle assembly for a lock includes a mounting plate fixed to a side of a door, a spindle, a shank, and a handle. The spindle is mounted in a central hole of the mounting plate and has a portion extending beyond the central hole of the mounting plate. The shank is securely engaged to the spindle to turn therewith. The shank includes an engaging portion having a polygonal outer periphery. The handle has an engaging hole configured complimentary to the polygonal outer periphery of the engaging portion of the shank. The handle has a grip extending therefrom. The engaging hole extends from a side of the handle to the other side of the handle. The engaging hole of the handle is releasably engaged with the engaging portion of the shank, with the grip being located in one of at least three positions with respect to the shank.

### BACKGROUND OF THE INVENTION

1. Field of the Invention

The present invention relates to an adjustable handle assembly for a lock that can be mounted to either a left-handed door or a right-handed door and that can be adjusted to a desired position.

2. Description of the Related Art

FIG. 1 of the drawings illustrates a conventional lock 91 that is mounted to either a left portion or a right portion of a door 90. A push along a clockwise or counterclockwise direction on either handle 92 of the lock causes the latch bolt 94 of the latch mechanism 93 to retreat. FIG. 2 of the drawings, which corresponds to FIG. 1 of U.S. Pat. No. 5,286,074, discloses a handle lock having two handles 81 to be symmetrically fixed on the inner and the outer bearing plate fixed on the inner and the outer side of a door. Each handle 81 has a hole 82 in an end thereof for engaging with an end 84 of a spindle 83. The end 84 of the spindle 83 has a round hole 85 into which an end of a cap 86 is inserted, with an annular groove 87 in the end of the cap 86 being aligned with a radial screw hole 88 in the spindle 83, and with a bolt 89 extending through the radial screw hole 88 into the annular groove 87 of the cap 86. The lock does not provide a locking function and thus could only be used with doors that need not to be locked. Further, it was found that the handle 81 of lever type drooped after a period of time due to its gravity and fatigue of the return spring 80. The aesthetically impression is adversely affected, as the handle 81 no longer lies on the horizontal plane.

### SUMMARY OF THE INVENTION

An object of the present invention to provide an adjustable handle assembly for a lock that can be mounted to either a left-handed door or a right-handed door.

Another object of the present invention is to provide an adjustable handle assembly that can be used with either a lock without locking function or a lock with locking function.

A further object of the present invention is to provide an adjustable handle assembly for a lock that can be adjusted to a desired position when the handle droops due to use after a period of time or improper installation.

An adjustable handle assembly for a lock in accordance with the present invention includes a mounting plate, a spindle, a shank, and a handle. The mounting plate is fixed to a side of a door. The spindle is mounted in a central hole of the mounting plate and has a portion extending beyond the central hole of the mounting plate. The shank is securely engaged to the spindle to turn therewith. The shank includes an engaging portion having a polygonal outer periphery. The handle has an engaging hole configured complimentary to the polygonal outer periphery of the engaging portion of the shank. The handle has a grip extending therefrom. The engaging hole extends from a side of the handle to the other side of the handle. The engaging hole of the handle is releasably engaged with the engaging portion of the shank, with the grip being located in one of at least three positions with respect to the shank.

Other objects, specific advantages, and novel features of the invention will become more apparent from the following detailed description and preferable embodiments when taken in conjunction with the accompanying drawings.

### BRIEF DESCRIPTION OF THE DRAWINGS

FIG. 1 is an elevational view illustrating installation of a conventional lock to a door.

FIG. 2 is an exploded perspective view of a conventional lock.

FIG. 3 is an exploded perspective view of an adjustable handle assembly for a lock in accordance with the present invention.

FIG. 4 is a perspective view of the adjustable handle assembly in accordance with the present invention.

FIG. 5 is an elevational view of the adjustable handle assembly adapted to be mounted to a right-handed door.

FIG. 6 is an elevational view of the adjustable handle assembly adapted to be mounted to a left-handed door.

FIG. 7 is a view similar to FIG. 6, illustrating drooping of the handle.

FIG. 8 is view of the adjustable handle assembly in FIG. 7 after adjustment.

FIG. 9 is a view similar to FIG. 6, illustrating a modified embodiment of the adjustable handle assembly in accordance with the present invention.

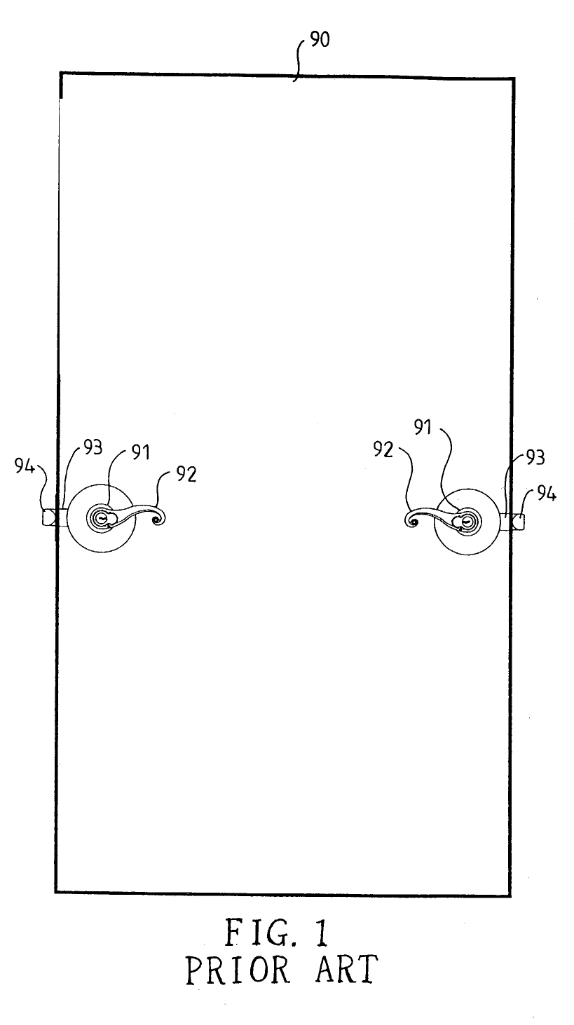

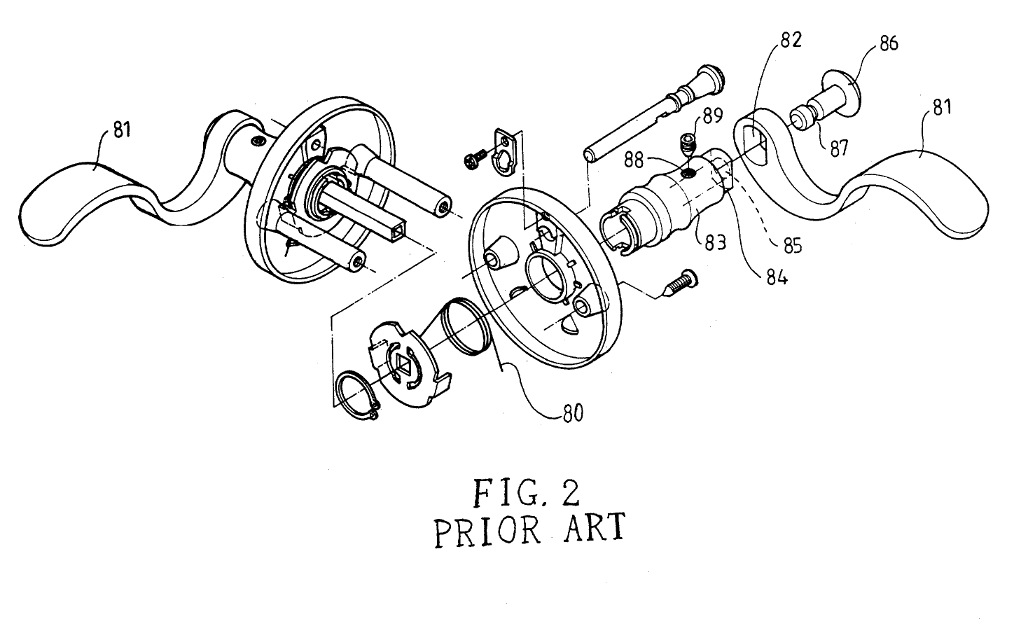

### DETAILED DESCRIPTION OF THE PREFERRED EMBODIMENTS

Preferred embodiments in accordance with the present invention will now be described with reference to the accompanying drawings.

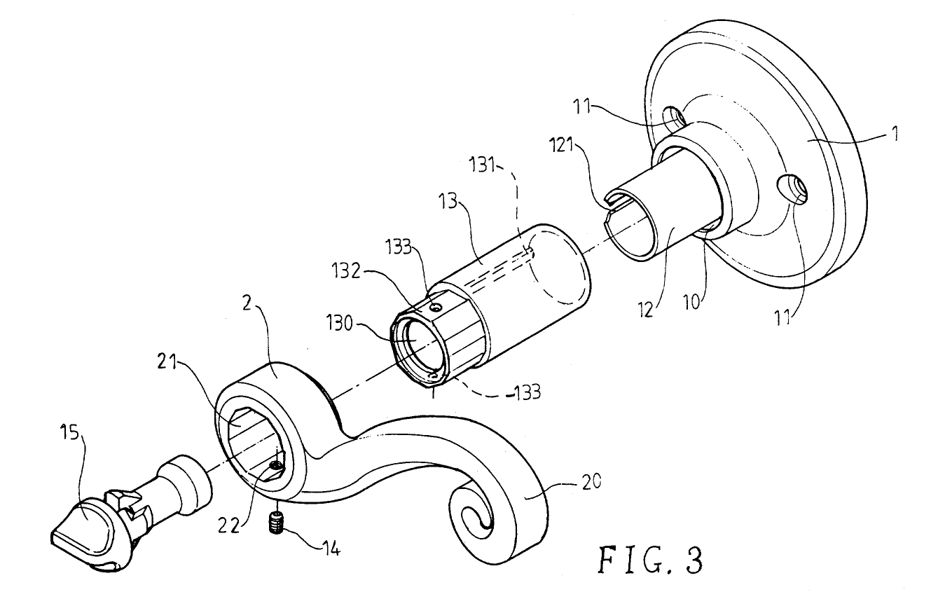

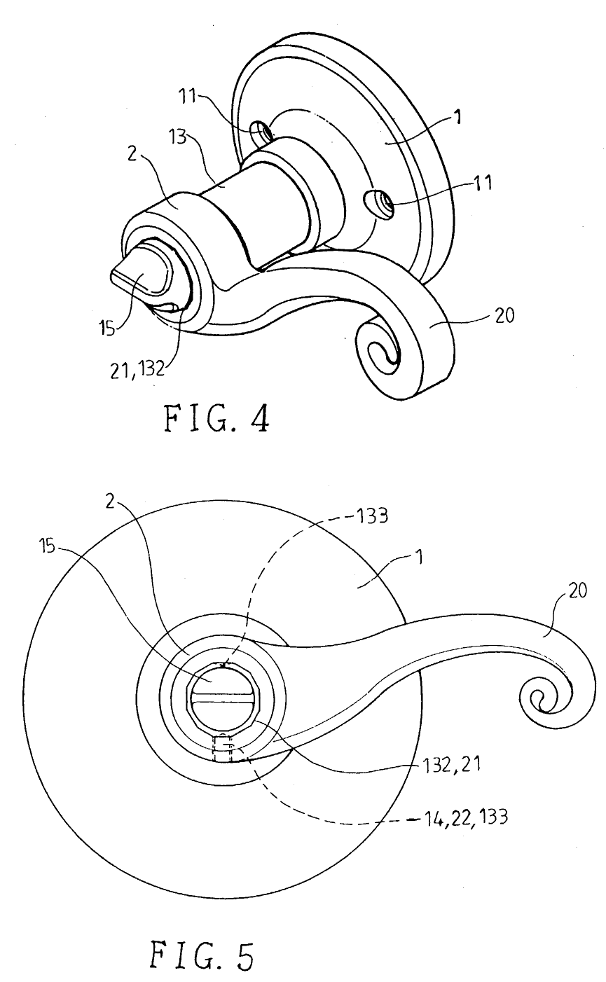

Referring to FIGS. 3 and 4, an adjustable handle assembly in accordance with the present invention generally includes a mounting plate 1 and a handle 2. The mounting plate 1 includes a plurality of holes 11 through which screws (not shown) extend to thereby fix the mounting plate 1 to a side of a door. The mounting plate 1 further includes a central hole 10 for receiving a portion of a spindle 12. The spindle 12 is so configured to provide an unlatching function, which is conventional and therefore not described in detail. A shank 13 is securely engaged with the spindle 12 to allow joint rotation of the shank 13 and the spindle 12. In this embodiment, the shank 13 has a rib 131 on an inner periphery thereof for engaging with a slot 121 of the spindle 12. The shank 13 has an engaging portion 132 on an end thereof. The engaging portion 132 has a polygonal outer periphery with at least one transverse positioning hole 133 defined therein and extending in a radial direction. The transverse positioning hole 133 may be a countersink for receiving a fastener 14 for the purpose of engaging with the handle 2. Preferably, the polygonal outer periphery includes at least twelve faces. The shank 130 includes a longitudinal through-hole 130 for receiving a locking means 15 such as a lock core assembly or a push button for locking purposes.

The handle 2 includes a grip 20 extending therefrom and having a desired shape. The handle 2 further has a hole 21 for engaging with the engaging portion 132 of the shank 13. The hole. 21 has an inner periphery that is configured complimentary to the polygonal outer periphery of the engaging portion 132 of the shank 13. Thus, the handle 2 can be mounted to the engaging portion 132 of the shank 13 in a desired position. A transverse positioning hole 22 is defined in the handle 2 and extends in a radial direction to thereby communicate with the hole 21. A fastener 14 is extended through the positioning hole 22 of the handle 2 into the associated positioning hole 133 of the shank 13, thereby securely fixing the handle 2 to the shank 13.

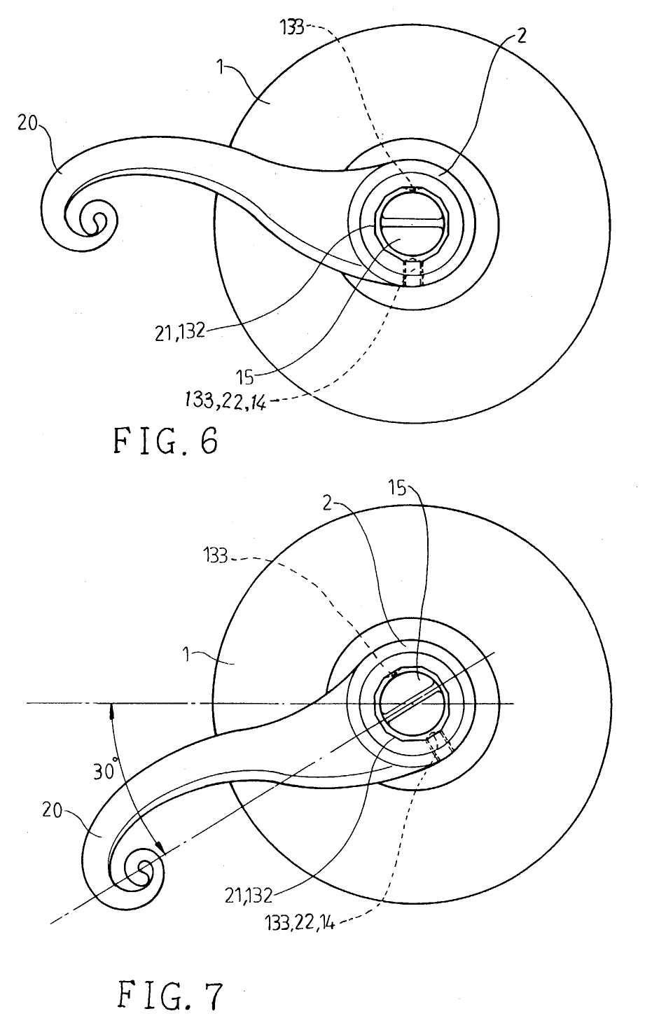

Referring to FIG. 5, the handle 2 is engaged with the engaging portion 132 of the shank 13 and fixed in place by the fastener 14, with the grip 20 of the handle 2 being located on the right side of the mounting plate 1. Thus, the handle 2 can be pushed downward along a clockwise direction. Referring to FIG. 6, the handle 2 is engaged with the engaging portion 132 of the shank 13, with the grip 20 of the handle 2 being located on the left side of the mounting plate 1. Thus, the handle 2 can be pushed downward along a counterclockwise direction. Accordingly, the handle assembly in accordance with the present invention may be mounted to either a left-handed door or a right-handed door.

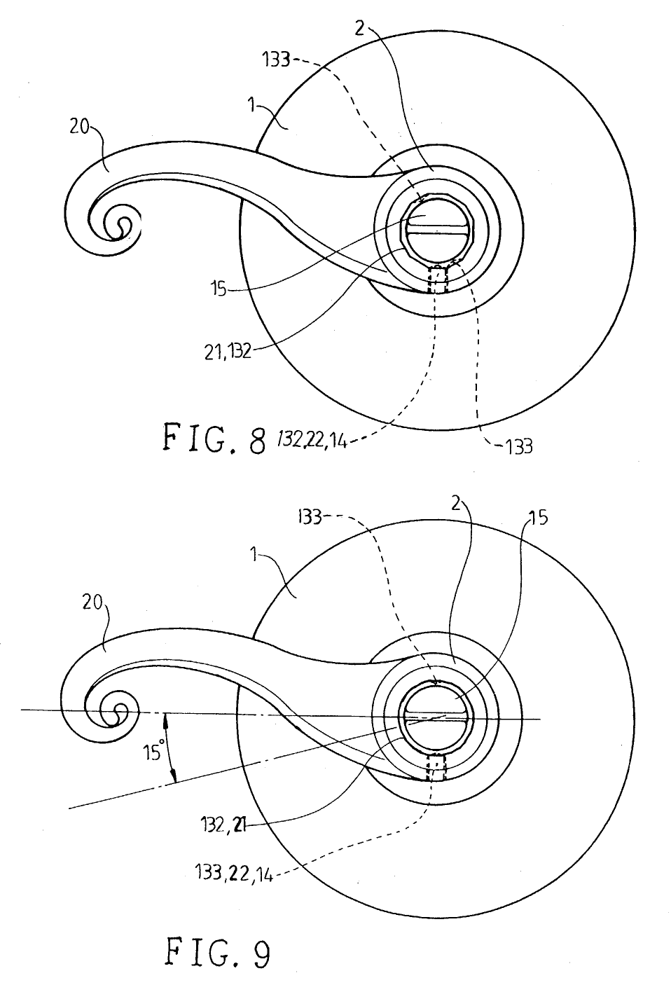

Referring to FIG. 7, in a case that the grip 20 of the handle 2 droops due to improper installation or gravity as a result of fatigue of the return spring (not shown) for returning the handle 2, adjustment is required. First, the fastener 14 and the handle 2 are removed. Next, the handle 2 is turned through, e.g., 30 degrees (depending on the drooping extent) until the grip 20 is again located on a horizontal plane. Then, the handle 2 is engaged with the engaging portion 132 of the shank 13 while keeping the grip 20 on the horizontal plane, and the fastener 14 is mounted again to fix the handle 2 in place, best shown in FIG. 8. The engaging portion 132 with twelve faces allows an adjustment of at least 30 degrees. An engaging portion with twenty-four faces will allow an adjustment of at least 15 degrees, as shown in FIG. 9. If the engaging portion has only six faces, the adjustment would be at least sixty degrees, which cannot be used to correct small drooping of the grip 20 of the handle 2.

The handle assembly in accordance with the present invention can be mounted to either a left side or a right side of a door. Thus, a manufacturer may produce only one type of the handle assembly. Further, the handle assembly can be used with locks having a lock core assembly or a push button for locking, e.g., a bathroom. The handle assembly can also be used with locks without locking function. The manufacture cost is reduced. Further, wrong purchase by the customers is eliminated. Further, drooping or improper installation of the handle can be easily corrected through simple adjustment.

Although the invention has been explained in relation to its preferred embodiments as mentioned above, it is to be understood that many other possible modifications and variations can be made without departing from the scope of the invention. It is, therefore, contemplated that the appended claims will cover such modifications and variations that fall within the true scope of the invention.

What is claimed is:

1. An adjustable handle assembly for a lock comprising:
a mounting plate adapted to be fixed to a side of a door, the mounting plate having a central hole;
a spindle mounted in the central hole of the mounting plate and having a portion extending beyond the central hole of the mounting plate;
a shank securely engaged to the spindle to turn therewith, the shank including an engaging portion having a polygonal outer periphery; and
a handle having an engaging hole configured complimentary to the polygonal outer periphery of the engaging portion of the shank, the handle having a grip extending therefrom, the engaging hole extending from a side of the handle to another side of the handle, the engaging hole of the handle being releasably engaged with the engaging portion of the shank, with the grip being located in one of at least three positions with respect to the shank.

2. The adjustable handle assembly for a lock as claimed in claim 1, wherein the shank has a longitudinal hole for receiving a locking means.

3. The adjustable handle assembly for a lock as claimed in claim 1, wherein the engaging portion of the shank has at least one positioning hole extending in a radial direction.

4. The adjustable handle assembly for a lock as claimed in claim 1, wherein the outer periphery of the engaging portion of the shank has twelve faces.

5. The adjustable handle assembly for a lock as claimed in claim 1, wherein the outer periphery of the engaging portion of the shank has twenty-four faces.
